(19) United States
(12) Patent Application Publication
(10) Pub. No.: US 2026/0120368 A1
(43) Pub. Date: Apr. 30, 2026

(54) VIRTUAL MAKEUP SOLUTION PROVIDING SYSTEM USING GENERATIVE ARTIFICIAL INTELLIGENCE

(71) Applicants: AMOREPACIFIC CORPORATION, Seoul (KR); KOREA ADVANCED INSTITUTE OF SCIENCE AND TECHNOLOGY, Daejeon (KR)

(72) Inventors: Seongmin JEONG, Yongin-si (KR); Myeongjin GOH, Yongin-si (KR); Geonyeong PARK, Daejeon (KR); Serin YANG, Daejeon (KR); Hee Chan JEON, Yongin-si (KR); Inhwa HAN, Daejeon (KR); Jongchul YE, Daejeon (KR)

(73) Assignees: AMOREPACIFIC CORPORATION, Seoul (KR); KOREA ADVANCED INSTITUTE OF SCIENCE AND TECHNOLOGY, Daejeon (KR)

(21) Appl. No.: 19/375,582

(22) Filed: Oct. 31, 2025

(30) Foreign Application Priority Data
Oct. 31, 2024 (KR) 10-2024-0153114
Jan. 3, 2025 (KR) 10-2025-0001135

(51) Int. Cl. G06T 11/60; G06T 11/10; G06V 10/26; G06V 10/56; G06V 10/82; G06V 40/16

(52) U.S. Cl. CPC G06T 11/60; G06T 11/10; G06V 10/26; G06V 10/56; G06V 10/82; G06V 40/171; G06V 40/172

(57) ABSTRACT

A virtual makeup solution providing system using generative AI is provided, and includes a user terminal that photographs a face and outputs a makeup image with virtual makeup applied to the face, and a makeup service providing server including a receiving part that receives a face image from the user terminal, a feature extraction part that analyzes and classifies the face image with a pre-built feature extraction model to output facial feature information, a color extraction part that inputs the facial feature information into a pre-built LLM (Large Language Model)-based generative AI (Generative Artificial Intelligence) to extract a makeup color corresponding to the facial feature information, and a virtual makeup part that outputs a makeup image with virtual makeup applied using diffusion-based generative AI that implants the extracted makeup color onto the face image.

### CROSS-REFERENCE TO RELATED PATENT APPLICATION

This application claims the benefit of Korean Patent Application No. 10-2024-0153114, filed on Oct. 31, 2024, and Korean Patent Application No. 10-2025-0001135, filed on Jan. 3, 2025, with the Korean Intellectual Property Office, the disclosures of which are incorporated herein by reference in their entirety.

### TECHNICAL FIELD

The present invention relates to a virtual makeup solution providing system using generative artificial intelligence (AI), and more particularly to a virtual makeup solution providing system capable of extracting a makeup color optimal for facial feature information, synthesizing the makeup color onto a face image with diffusion-based generative AI, and providing a makeup image.

### BACKGROUND

Modern society is an era of advanced technology convergence, and various attempts exist to captivate customers through innovative and smart services incorporating IT technology. Technological innovation in the beauty industry is also accelerating, and services or products using artificial intelligence are being launched in the beauty industry as well. In particular, as a generation that values personal preferences has rapidly emerged as a main consumer base of the beauty industry, the industry is presenting personalized beauty solutions more clearly and specifically through AI technology. In the beauty industry field, experiences are developing from a method that merely remained as a simple promotional method in the past to a method of recommending products in a customized manner through facial image analysis.

Recently, a method of performing virtual makeup using artificial intelligence is being proposed. For example, a prior art reference, Korean Patent Publication No. 2019-0116052 (published on Oct. 14, 2019) discloses a technology of extracting facial landmarks using a pre-built deep learning model, diagnosing a personal color with the facial landmarks, and then performing virtual makeup. In addition, Korean Patent No. 10-2515436 (published on Mar. 29, 2023) discloses a technology of acquiring a face image, dividing the face by parts to generate information for each part, extracting a makeup product for each part, and then applying it to be synthesized on a GAN basis to an area for each part.

Here, the technology disclosed in the former reference diagnoses a personal color only by looking at the appearance of a face, and is not a configuration that recommends an optimal makeup color by considering skin tone, iris color, or lip color. The technology disclosed in the latter reference synthesizes a color and a face with GAN, so a case may occur in which the face becomes different from the original in the synthesis process, which may give a sense of heterogeneity or discomfort.

### SUMMARY

An embodiment of the present invention is proposed to solve the above problems, and aims to provide a virtual makeup solution providing system using generative AI that can extract an optimal makeup color by considering not only the shape of a face but also the color, and in which the extracted makeup color can be naturally synthesized without a sense of heterogeneity from the original.

In addition, an embodiment of the present invention aims to provide a virtual makeup solution providing system using generative AI that, when a face is photographed in a user terminal, extracts facial feature information from a face image with a pre-built feature extraction model, inputs the facial feature information into a Large Language Model (LLM)-based generative AI to extract a makeup color corresponding to the facial feature information, and inputs the extracted makeup color into diffusion-based generative AI to enable generation of a makeup image without a sense of heterogeneity.

However, the technical problems to be achieved by the present embodiment are not limited to the technical problems as described above, and other technical problems may exist.

According to an embodiment of the present invention, there may be provided a virtual makeup solution providing system using generative AI comprising: a user terminal that photographs a face and outputs a makeup image with virtual makeup applied to the face; and a makeup service providing server including a receiving part that receives a face image from the user terminal, a feature extraction part that analyzes and classifies the face image with a pre-built feature extraction model to output facial feature information, a color extraction part that inputs the facial feature information into a pre-built LLM (Large Language Model)-based generative AI (Generative Artificial Intelligence) to extract a makeup color corresponding to the facial feature information, and a virtual makeup part that outputs a makeup image with virtual makeup applied using diffusion-based generative AI that implants the extracted makeup color onto the face image.

In addition, there may be provided the virtual makeup solution providing system using generative AI, wherein the pre-built feature extraction model recognizes a contour line of a face and facial components, selects facial feature points, analyzes a length, a ratio, and an angle of each part, and uses BiseNet (Bilateral Segmentation Network for Real-time Semantic Segmentation) to extract a skin tone of the face, a lip color, and an iris color.

In addition, there may be provided the virtual makeup solution providing system using generative AI, wherein the pre-built feature extraction model uses ResNet (Residual Neural Network), which is a classification model that classifies a face on the basis of preset classification items, based on the contour line of the face, facial components, facial feature points, a length, a ratio, and an angle of each part, a skin tone of the face, a lip color, and an iris color.

In addition, there may be provided the virtual makeup solution providing system using generative AI, wherein the pre-built LLM-based generative AI is trained using instruction tuning with a dataset of facial feature information and makeup colors, and then, when the facial feature information is input into the LLM-based generative AI, outputs a keyword of the makeup color.

In addition, there may be provided the virtual makeup solution providing system using generative AI, wherein the diffusion-based generative AI is Stable Diffusion, which is a Latent Diffusion Model.

In addition, there may be provided the virtual makeup solution providing system using generative AI, wherein the diffusion-based generative AI converts the keyword of the makeup color output from the LLM-based generative AI into a prompt to generate the makeup image.

In addition, there may be provided the virtual makeup solution providing system using generative AI, wherein the diffusion-based generative AI divides the face image into a preset makeup area; converts the keyword of the makeup color into a prompt for the divided makeup area to generate a unit makeup image; and then inserts and replaces the unit makeup image back into the face image, which is an original image, to generate the makeup image.

In addition, there may be provided the virtual makeup solution providing system using generative AI, wherein the makeup service providing server may further include a selection reflection part that, after a makeup color corresponding to the facial feature information is extracted, transmits a lip color among the makeup colors to the user terminal, and when a desired lip color is selected by the user terminal, extracts and presents an eye shadow color and a blusher color corresponding to the selected lip color based on a pre-built database.

In addition, there may be provided the virtual a makeup solution providing method executed by a makeup service providing server comprising: receiving a face image from a user terminal; analyzing and classifying the face image with a pre-built feature extraction model to output facial feature information; inputting the facial feature information into a pre-built LLM (Large Language Model)-based generative AI (Generative Artificial Intelligence) to extract a makeup color corresponding to the facial feature information; and outputting a makeup image with virtual makeup applied using diffusion-based generative AI that implants the extracted makeup color onto the face image.

In addition, there may be provided the virtual makeup solution providing method using generative AI, wherein the LLM-based generative AI is generative AI trained with instruction tuning using a dataset of facial feature information and makeup colors.

According to an embodiment of the present invention, it is possible to extract and recommend a makeup color that matches not only a shape of a user's face but also a color of the face, and by generating a makeup image without a sense of heterogeneity as if actual makeup was applied even without actually applying makeup using a product, it is possible to not only recommend an optimal makeup color and product suitable for an individual, but also induce an accurate and fast purchasing decision.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a drawing for explaining a virtual makeup solution providing system using generative AI according to an embodiment of the present invention.

FIG. 2 is a block diagram for explaining a makeup service providing server included in the system of FIG. 1.

FIG. 3 is a drawing for explaining an entire process of a virtual makeup service providing method according to an embodiment of the present invention.

FIGS. 4 to 22 are drawings for explaining an embodiment in which a virtual makeup service according to an embodiment of the present invention is implemented.

FIG. 23 is an operation flowchart for explaining a virtual makeup service providing method according to an embodiment of the present invention.

### DETAILED DESCRIPTION OF EXEMPLARY EMBODIMENTS

Hereinafter, embodiments of the present invention will be described in detail so that a person having ordinary knowledge in the technical field to which the present invention pertains can easily implement them by referring to the accompanying drawings. However, the present invention may be implemented in various different forms and is not limited to the embodiments described herein. In addition, in the drawings, parts not related to the description are omitted in order to clearly explain the present invention, and similar reference numerals are attached to similar parts throughout the specification.

Throughout the specification, when a certain part is “connected” to another part, this includes not only a case of being “directly connected” but also a case of being “electrically connected” with another element interposed therebetween. In addition, when a certain part “includes” a certain component, this means that it may further include other components rather than excluding other components unless specifically stated to the contrary, and it should be understood that it does not exclude in advance the existence or addition possibility of one or more other features, numbers, steps, operations, components, parts, or combinations thereof.

The terms “about,” “substantially,” and the like, which are used throughout the specification as terms of approximation, are used in a meaning at or close to the numerical value when a manufacturing and material tolerance inherent in the mentioned meaning is presented, and are used to prevent an unconscionable infringer from unfairly using the disclosed content in which an accurate or absolute numerical value is mentioned to help understanding of the present invention. The term “step of ˜ (doing)” or “step of ˜,” which is used throughout the specification of the present invention to indicate a degree, does not mean “step for ˜.”

In the present specification, ‘part’ includes a unit realized by hardware, a unit realized by software, and a unit realized using both. In addition, one unit may be realized using two or more pieces of hardware, and two or more units may be realized by one piece of hardware. Meanwhile, ‘˜part’ is not limited to a meaning of software or hardware, and ‘˜part’ may be configured to be in an addressable storage medium or may be configured to reproduce one or more processors. Therefore, as an example, ‘˜part’ includes components such as software components, object-oriented software components, class components, and task components, and processes, functions, attributes, procedures, subroutines, segments of program code, drivers, firmware, microcode, circuits, data, databases, data structures, tables, arrays, and variables. Functions provided in the components and ‘˜parts’ may be combined into a smaller number of components and ‘˜parts’ or may be further separated into additional components and ‘˜parts’. In addition, the components and ‘˜parts’ may be implemented to reproduce one or more CPUs in a device or a secure multimedia card.

In the present specification, some of the operations or functions described as being performed by a terminal, an apparatus, or a device may be performed instead in a server connected to the terminal, device, or device. Likewise, some of the operations or functions described as being performed by a server may also be performed in a terminal, device, or device connected to the server.

In the present specification, some of the operations or functions described as mapping or matching with a terminal may be interpreted as mapping or matching the terminal's identifying data, such as a unique number of the terminal or identification information of an individual.

Hereinafter, the present invention will be described in detail with reference to the accompanying drawings.

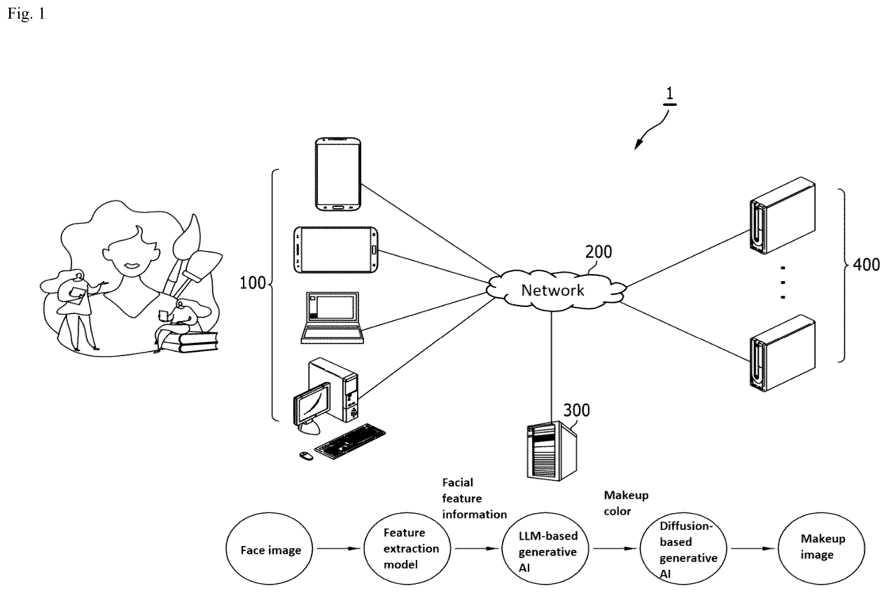

FIG. 1 is a drawing for explaining a virtual makeup solution providing system using generative AI according to an embodiment of the present invention. Referring to FIG. 1, a virtual makeup solution providing system 1 using generative AI may include at least one user terminal 100, a makeup service providing server 300, and at least one information providing server 400. However, since the virtual makeup solution providing system 1 using generative AI of FIG. 1 is merely an embodiment of the present invention, the present invention is not limitedly interpreted through FIG. 1.

Each component of FIG. 1 is generally connected through a network 200. For example, as shown in FIG. 1, at least one user terminal 100 may be connected to a makeup service providing server 300 through a network 200. In addition, the makeup service providing server 300 may be connected to at least one user terminal 100 and at least one information providing server 400 through the network 200. In addition, at least one information providing server 400 may be connected to the makeup service providing server 300 through the network 200.

Here, the network refers to a connection structure in which information exchange is possible between nodes, such as a plurality of terminals and servers, and examples of such a network include a Local Area Network (LAN), a Wide Area Network (WAN), the World Wide Web (WWW), a wired and wireless data communication network, a telephone network, a wired and wireless television communication network, and the like. Examples of a wireless data communication network include 3G, 4G, 5G, 3rd Generation Partnership Project (3GPP), 5th Generation Partnership Project (5GPP), 5G New Radio (NR), 6th Generation of Cellular Networks (6G), Long Term Evolution (LTE), World Interoperability for Microwave Access (WIMAX), Wi-Fi, the Internet, Local Area Network (LAN), Wireless Local Area Network (Wireless LAN), Wide Area Network (WAN), Personal Area Network (PAN), Radio Frequency (RF), a Bluetooth network, a Near-Field Communication (NFC) network, a satellite broadcasting network, an analog broadcasting network, a Digital Multimedia Broadcasting (DMB) network, and the like, but are not limited thereto.

Hereinafter, the term “at least one” is defined as a term including singular and plural, and it is obvious that each component may exist in singular or plural and may mean singular or plural even if the term “at least one” does not exist. In addition, the fact that each component is provided in singular or plural may be changed according to embodiments.

The user terminal 100 may be a terminal of a user that photographs a face using a web page, an app page, a program, or an application related to a virtual makeup service and outputs a makeup image with virtual makeup applied to the face.

Here, the user terminal 100 may be implemented as a computer capable of accessing a remote server or terminal through a network. Here, the computer may include, for example, a notebook, a desktop, a laptop, and the like equipped with navigation and a web browser. In this case, the user terminal 100 may be implemented as a terminal capable of accessing a remote server or terminal through a network. The user terminal 100 may be, for example, a wireless communication device ensuring portability and mobility, and may include all types of handheld-based wireless communication devices such as navigation, PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), Wibro (Wireless Broadband Internet) terminal, smartphone, smartpad, tablet PC, and the like.

The makeup service providing server 300 may be a server that provides a virtual makeup service web page, an app page, a program, or an application. The makeup service providing server 300 may be a server that receives a face image from the user terminal 100, extracts facial feature information with a pre-built feature extraction model, and then extracts a makeup color corresponding to the facial feature information with a pre-built LLM-based generative AI. In addition, the makeup service providing server 300 may be a server that synthesizes the extracted makeup color onto the face image with diffusion-based generative AI so that a sense of heterogeneity from the original is minimized. In addition, the makeup service providing server 300 may be a server that provides a makeup image, which is the result, to the user terminal 100.

Here, the makeup service providing server 300 may be implemented as a computer capable of accessing a remote server or terminal through a network. Here, the computer may include, for example, a notebook, a desktop, a laptop, and the like equipped with navigation and a web browser.

The information providing server 400 may be a server that provides a prototype of a feature extraction model, an LLM-based generative AI, and a diffusion-based generative AI, or information or a dataset for training them to the makeup service providing server 300 with or without using a web page, an app page, a program, or an application related to a virtual makeup service. As used herein, the prototype may be understood as an AI or a tool before being trained with a dataset in order to implement a solution according to an embodiment of the present invention. Here, the information providing server 400 may be implemented as a computer capable of accessing a remote server or terminal through a network. Here, the computer may include, for example, a notebook, a desktop, a laptop, and the like equipped with navigation and a web browser. In this case, at least one information providing server 400 may be implemented as a terminal capable of accessing a remote server or terminal through a network.

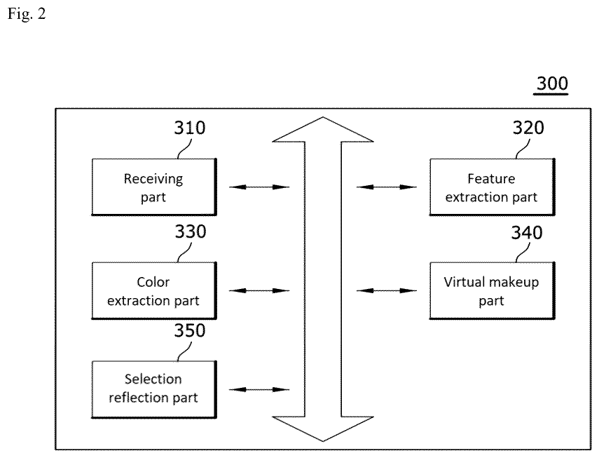

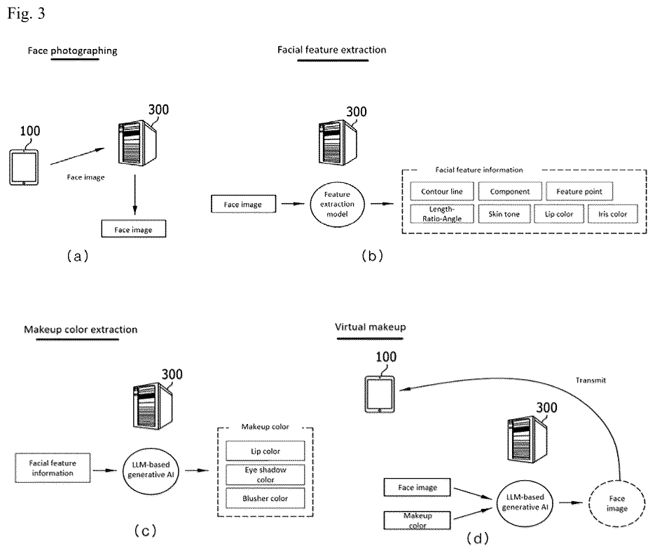

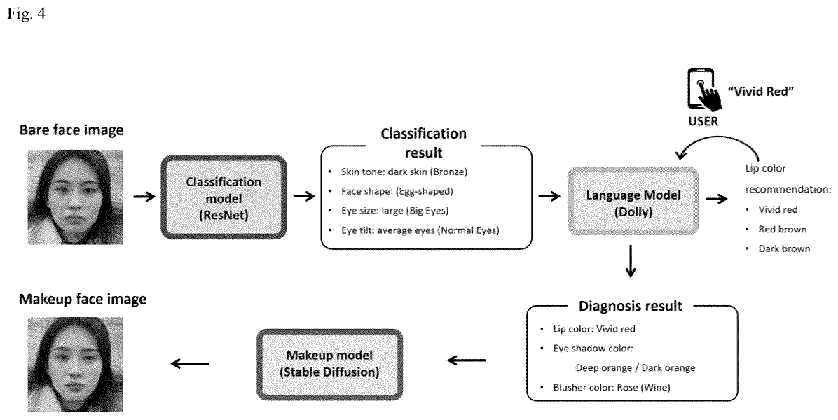

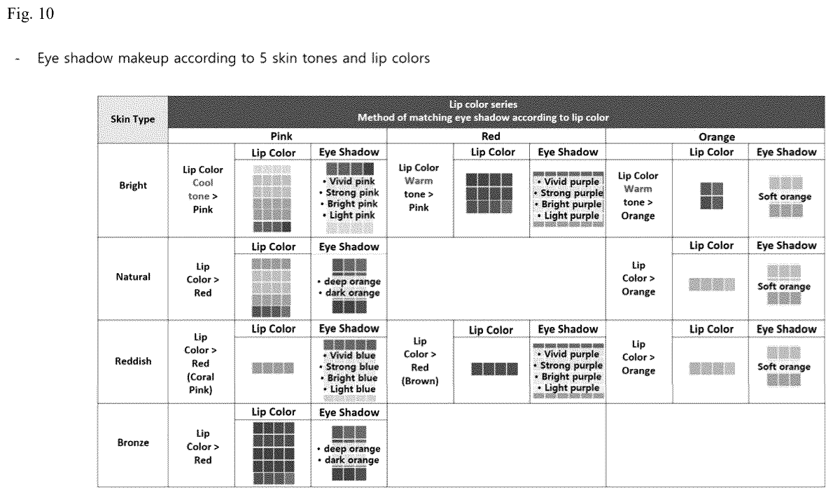

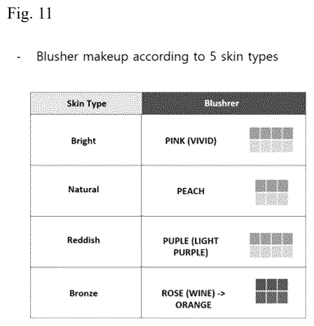

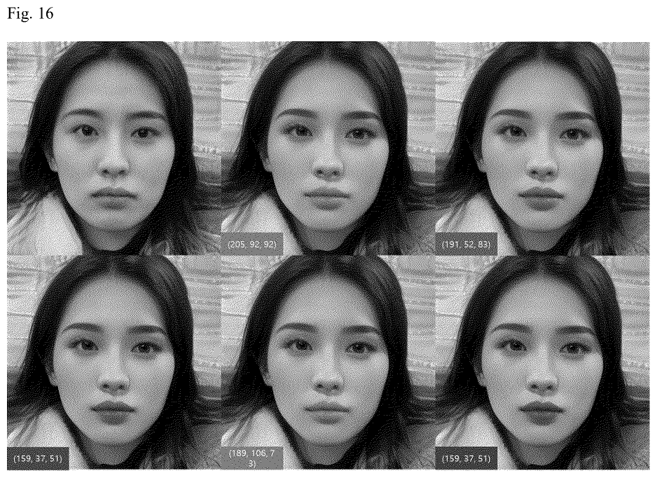

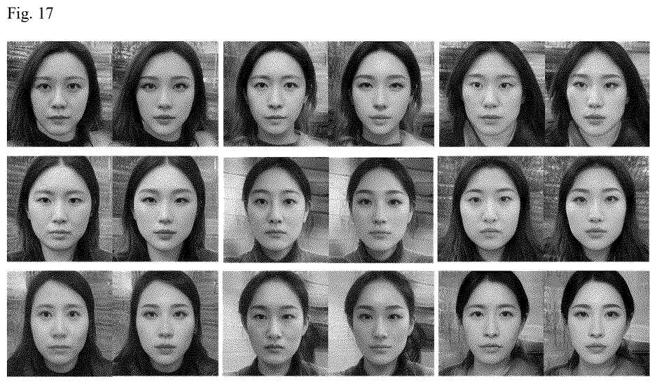

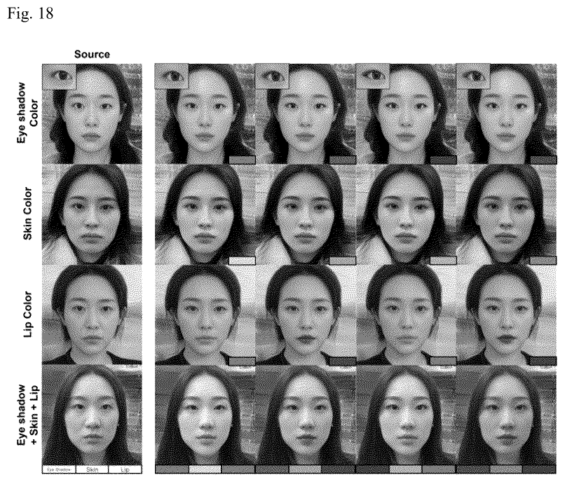

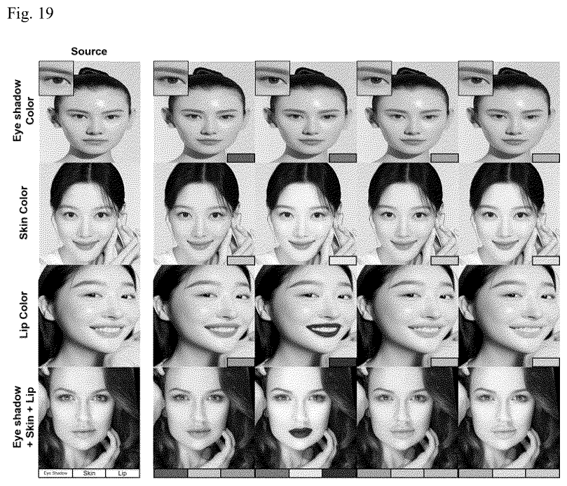

FIG. 2 is a block diagram for explaining a makeup service providing server included in the system of FIG. 1, FIG. 3 is a drawing for explaining an entire process of a virtual makeup service providing method according to an embodiment of the present invention, and FIGS. 4 to 22 are drawings for explaining an embodiment in which a virtual makeup service according to an embodiment of the present invention is implemented.

Referring to FIG. 2, the makeup service providing server 300 may include a receiving part 310, a feature extraction part 320, a color extraction part 330, a virtual makeup part 340, and a selection reflection part 350.

When the makeup service providing server 300 according to an embodiment of the present invention or another server (not shown) operating in conjunction transmits a virtual makeup service application, a program, an app page, a web page, and the like to the user terminal 100 and the information providing server 400, the user terminal 100 and the information providing server 400 may install or open the virtual makeup service application, the program, the app page, the web page, and the like. In addition, a service program may be driven in the user terminal 100 and the information providing server 400 using a script executed in a web browser. Here, the web browser is a program that enables use of a web (WWW: World Wide Web) service, and means a program that receives and displays hypertext described in HTML (Hyper Text Mark-up Language), and includes, for example, Chrome, Microsoft Edge, Safari, FireFox, Whale, UC browser, and the like. In addition, the application means an application on a terminal, and includes, for example, an app executed in a mobile terminal (smartphone).

Before describing each component according to an embodiment of the present invention in detail below, the overall process may be summarized as follows.

Virtual makeup solution using generative AI
Extract facial feature information by inputting a face image into a feature extraction model
Extract a makeup color by inputting the facial feature information into an LLM-based generative AI
Generate a makeup image by inputting the makeup color into a diffusion-based generative AI

Referring to FIG. 2, the receiving part 310 may receive a face image from the user terminal 100. In this case, data transmitted to the receiving part 310 may be an image including a face rather than a face image. The user terminal 100 may photograph a face and upload the photographed face image.

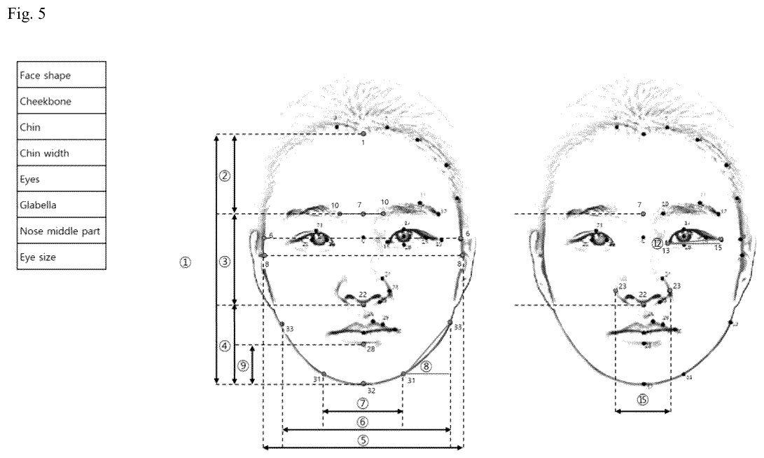

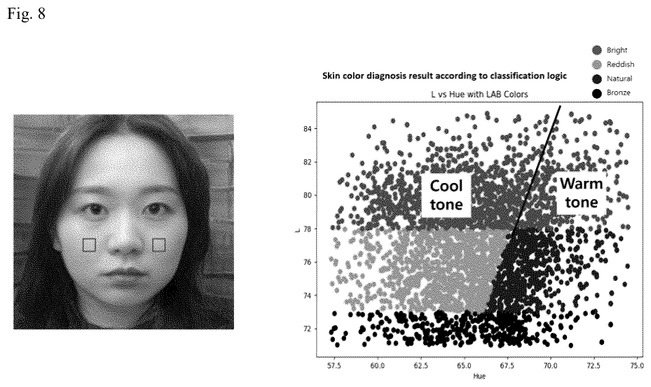

The feature extraction part 320 may analyze and classify the face image with a pre-built feature extraction model to output facial feature information. A feature extraction model according to an embodiment of the present invention may include a [shape extraction model] that extracts contour lines, facial components, and feature points in order to determine facial morphology, a [color extraction model] that extracts a skin tone of the face, a lip color, and an iris color, and a [classification model] for classifying a user's face with the extracted facial feature information. Here, the feature points may correspond to landmarks as shown in FIG. 5, but are not limited thereto. Various known models may be used as a foundation model of each model, and first, the [shape extraction model] may use ResNet to extract contour lines, facial components, and feature points. In this case, BiseNet (Bilateral Segmentation Network for Real-time Semantic Segmentation) may also be used for face segmentation, but a model for segmentation is not limited thereto. In addition, the [color extraction model] may be, for example, a color extraction and classification model that classifies into bright skin, red skin, natural skin, and tanned skin based on LAB color as shown in FIG. 8. In this connection, various known technologies exist, including Korean Patent Publication No. 2023-0122242 (published on Aug. 22, 2023) of the present applicant, for a method of extracting skin tone and the like, and, therefore, a detailed description will be omitted.

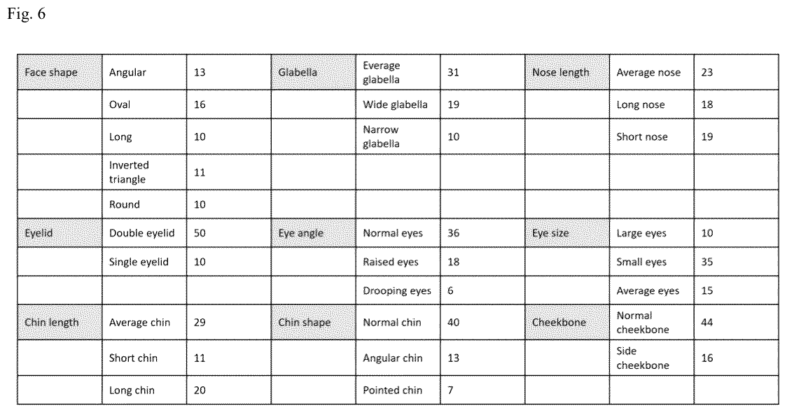

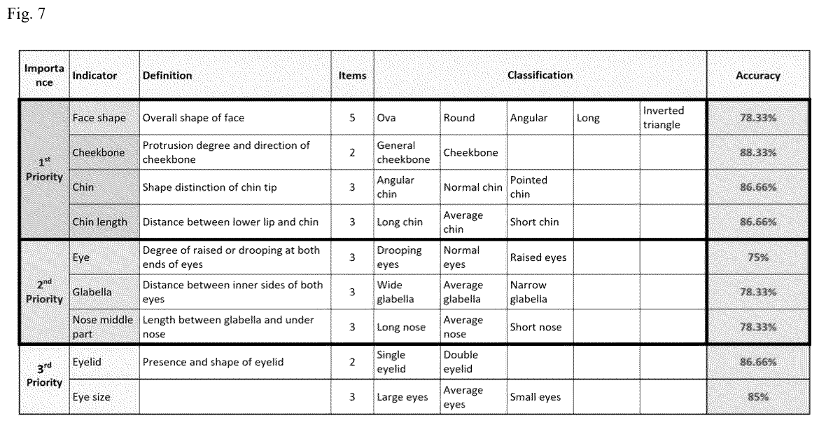

The [classification model] may classify a face on the basis of preset classification items, based on a contour line of the face, facial components, facial feature points, a length, a ratio, and an angle of each part, a skin tone of the face, a lip color, and an iris color. For example, as shown in FIG. 7, by looking at a contour line of a face, it may be classified whether a face shape is an oval shape, a round shape, an angular shape, a long shape, an inverted triangle shape, and the like; cheekbones may also be classified into general cheekbones or side cheekbones according to a protrusion degree and a direction; a chin may also be classified into an angular chin, a general chin, a pointed chin; and a chin length may also be classified into long, average, or short; eyes may also be classified into drooping or raised; the distance between the eyes may also be classified as wide or narrow; a nose length may also be classified into long or short; eyelids may also be classified into double eyelids or single eyelids; and eye size may also be classified into small or large. In this regard, a reference value for distinguishing between long and short, wide and narrow, and the like may be the same as FIG. 6 (a test set generated for 60 people), but this is also not limited to this data only. Of course, since various classification models may exist in addition to this, it is not limited thereto.

The color extraction part 330 may input the facial feature information into a pre-built LLM (Large Language Model)-based generative AI (Generative Artificial Intelligence) to extract a makeup color corresponding to the facial feature information. In this case, the pre-built LLM-based generative AI, after being trained using instruction tuning with a dataset of facial feature information and makeup colors, when the facial feature information is input into the LLM-based generative AI, may output a keyword of the makeup color. In an embodiment of the present invention, a makeup color may be extracted in two steps. In a first step, a color corresponding to a preset part is recommended, and when this is provided to a user and feedback is received, a method of recommending a color corresponding to another part in response thereto may be used.

In an embodiment, after recommending a lip color with facial feature information (the first step), when a lip color is selected in the user terminal 100, an eye shadow color and a blusher color corresponding to the selected lip color are recommended (the second step). This is summarized as Table 1 below.

TABLE 1
LLM-based generative AI

| | |
|---|---|
| First step | Recommend a lip color using facial feature |
| | information |
| Second step | Recommend an eye shadow color and a blusher |
| | color corresponding to the selected lip color |

### <LLM-Based Generative AI>

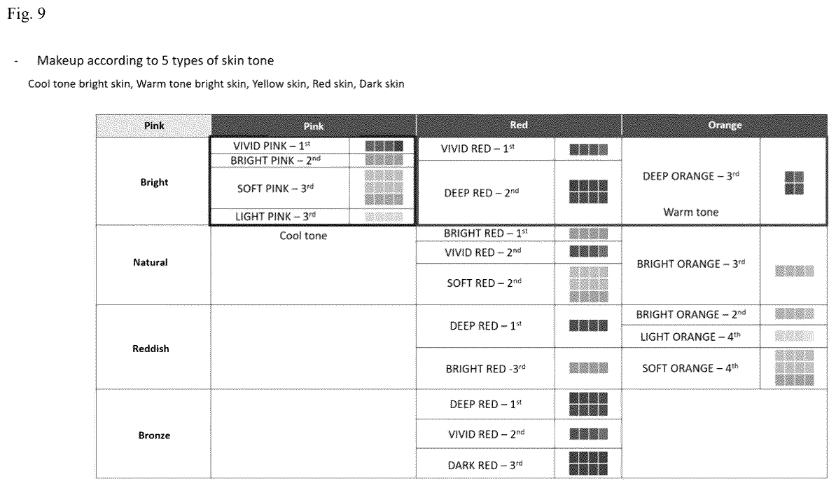

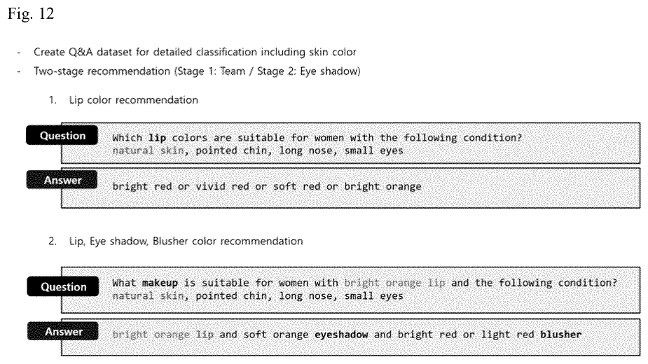

The LLM-based generative AI may use Dolly, which is open source, but is not limited thereto. In this connection, Dolly is a Large Language Model (LLM) of Databricks that is permitted for commercial use. The LLM-based generative AI may be generative AI that is instruction-tuned using a dataset of [facial feature information-makeup color]. Here, in order to build a dataset, a preparation process and a preprocessing process of preparing and processing data on makeup solutions by type, makeup guidelines, and makeup products may be required. In this regard, when explaining in accordance with the above-described two steps, as shown in FIGS. 9 to 11, it may be generative AI trained and adjusted using datasets of [facial feature information-lip color] and [lip color-eye shadow color-blusher color]. In this case, the facial feature information may be information expressing facial morphology as shown in FIG. 12, for example, a pointed chin, small eyes, a long nose, and the like, and may be information expressing a face color, for example, a natural skin tone and the like, but is not limited thereto.

The virtual makeup part 340 may output a makeup image with virtual makeup applied using diffusion-based generative AI that implants the extracted makeup color onto the face image. The term “implanting” is used to differentiate the present invention's synthesis using diffusion-based generative AI from conventional virtual makeup in which a makeup color is overlaid on a face image. It is noted that this term may be replaced with the word “synthesis” if it is ambiguous.

The user terminal 100 may output a makeup image with virtual makeup applied to a face. Here, the diffusion-based generative AI may be Stable Diffusion, which is a Latent Diffusion Model. In this case, Stable Diffusion may be understood as a Text-to-Image artificial intelligence model distributed under an open source license.

This model is largely composed of three artificial neural networks called CLIP, UNet, and VAE (Variational Auto Encoder). When a user inputs text, a text encoder (CLIP) converts the user's text into a language that UNet can understand called a token, wherein UNet uses a method of denoising randomly generated noise based on the token. When denoising is repeated, a proper image is generated, and the role of VAE is to convert this image into pixels. Unlike conventional diffusion probabilistic image generation models that use resources exponentially as resolution increases, by introducing an auto-encoder at the front and back to insert or remove noise in a latent space of a much smaller dimension rather than an entire image, the resource usage is significantly reduced even when generating an image of a relatively large resolution, so that use is possible even with a graphics card of a general household.

### <Diffusion-Based Generative AI>

The diffusion-based generative AI according to an embodiment of the present invention may convert a keyword of a makeup color output from the LLM-based generative AI into a prompt to generate a makeup image. Continuing to refer to the above-described example, if a makeup color suitable for [pointed chin-small eyes-long nose-natural skin tone] is selected as [lip color-bright orange], [eye shadow color-soft orange], [blusher-light red], this is converted into a prompt to generate a makeup image. At this time, a prompt in a form of “apply make up with a lip color as bright orange, an eye shadow as soft orange, and a blusher as light red” may be generated. Since input items are the same or similar, a prompt form (format) may be predetermined and a Text-to-Text generative AI for prompt generation may be separately prepared so that a prompt may be generated by changing only a color or a product to be included therein.

### <Customization>

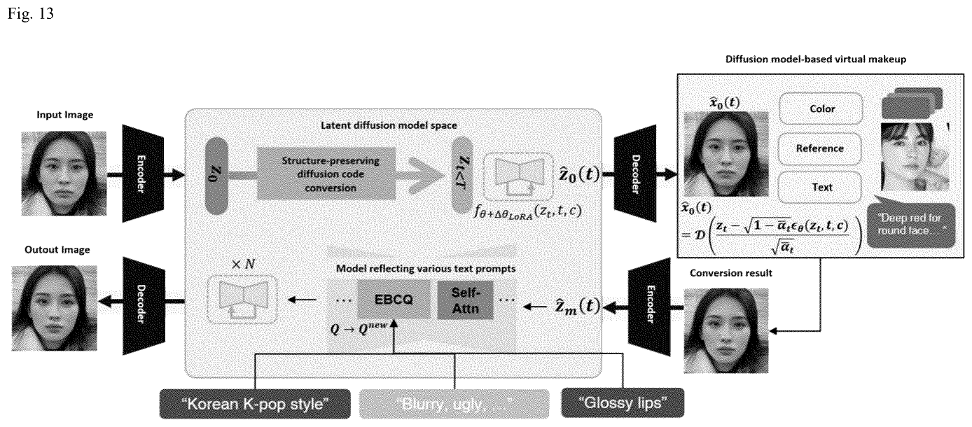

Referring to FIG. 13, in addition to applying makeup (color) to a face image using the above-described makeup color, customization based on [reference] or [text], such as desiring makeup like facial makeup of a reference image, or desiring makeup of a K-pop idol style, and the like, may be possible.

At this time, early stopping DDIM (Denoising Diffusion Implicit Models) inversion is used to preserve facial structure and identity while enabling extensive customization through various conditional inputs, such as a reference image, a specific RGB color, or a text description. Accordingly, makeup color keywords output from the above-described LLM-based generative AI can be formulated as prompts and applied to image generation, and can also be utilized for techniques such as makeup transfer. A model according to an embodiment of the present invention was evaluated by 15 makeup experts in terms of makeup completeness and realism, and was determined to produce significantly high-quality results, thereby verifying its technical capabilities. For detailed information on DDIM, reference is made to the following paper (Song, Jiaming, Chenlin Meng, and Stefano Ermon, “Denoising diffusion implicit models.” arXiv preprint arXiv: 2010.02502 (2020).).

### <Segmentation-Makeup-Merging>

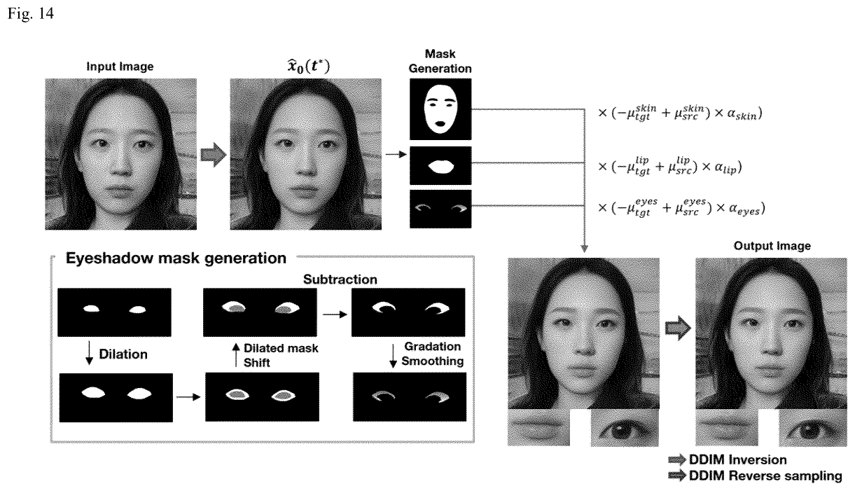

The diffusion-based generative AI according to an embodiment of the present invention may divide a face image into a preset makeup area as shown in FIG. 14, convert a keyword of a makeup color into a prompt for the divided makeup area to generate a unit makeup image, and then insert and replace the unit makeup image back into a face image, which is an original image, to generate a makeup image. Referring to FIG. 14, it can be seen that a remaining area excluding eyes, eyebrows, and lips, an eye area, and a lip area are separated from a face, respectively. An eye shadow should be applied to an area larger than the eye area, and for this, as shown in the lower left, an effect like an eye shadow being applied may be provided through a process of [eye area-eye area dilation-mask shift-subtraction-gradation smoothing]. A lip color or a blusher is also similar if the dilation or subtraction operation and the like are removed. When makeup of each part is finished in this way, this is synthesized onto an original image, that is, a face image. By doing this, a state in which makeup is applied without greatly differing from the original is maintained. Here, ‘skin’ means skin, ‘lip’ means a lip (lips), and ‘eyes’ mean eyes. ‘src’ is an abbreviation of source, which is an original image, ‘tgt’ means an abbreviation of target, which is a target image, that is, a makeup image, and alpha may mean a weight for each part.

The selection reflection part 350, after a makeup color corresponding to the facial feature information is extracted, may transmit a lip color among the makeup colors to the user terminal 100, and when a desired lip color is selected by the user terminal 100, may extract and present an eye shadow color and a blusher color corresponding to the selected lip color based on a pre-built database. This process was explained through Table 1, and therefore, a redundant description will be omitted.

An entire process according to an embodiment of the present invention may be summarized as shown in (a) to (d) of FIG. 3. Drawings for each step are as shown in Table 2 below.

TABLE 2

| Step | Model type | Drawing |
|---|---|---|
| Entire process | | FIG. 4 |
| \textcircled{1} | Feature extraction model | FIG. 5 to FIG. 8 |
| \textcircled{2} | LLM-based generative AI | FIG. 9 to FIG. 12 |
| \textcircled{3} | Diffusion-based generative AI | FIG. 13 to FIG. 14 |

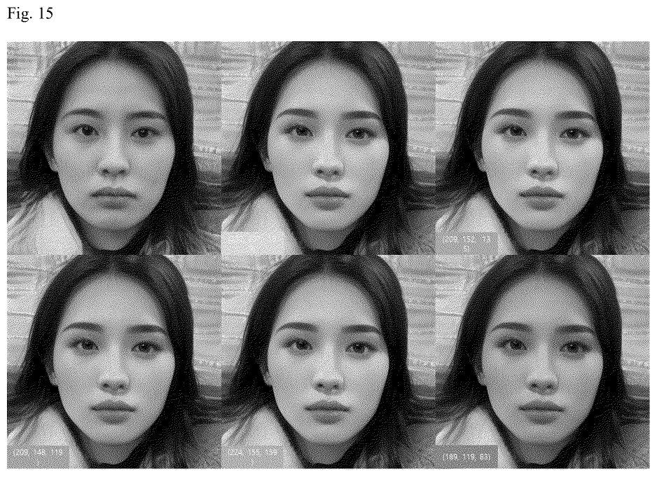

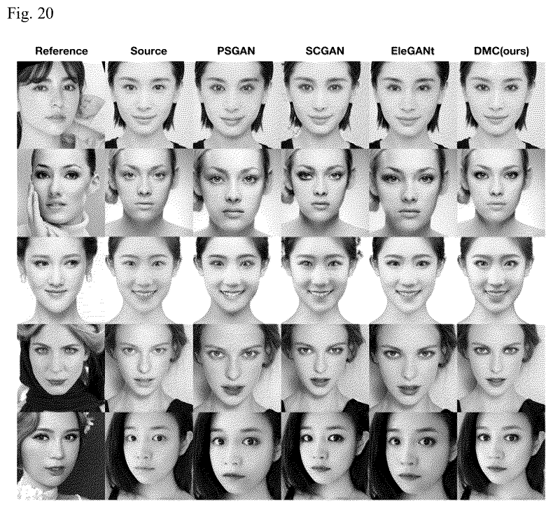

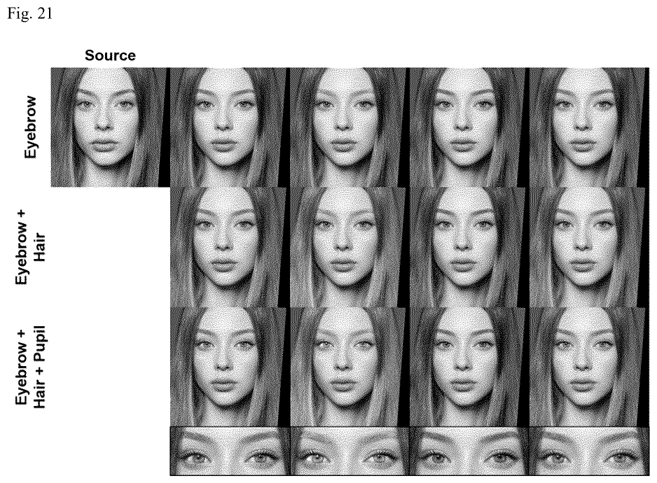

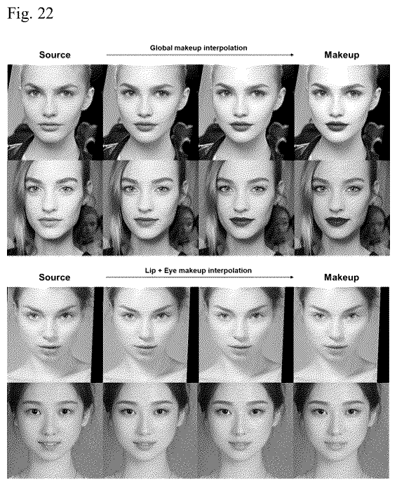

FIGS. 15 to 19 are examples of performing RGB-based makeup, and FIG. 20 is an example of performing reference image-based makeup. In this case, DMC (Diffusion Model Customization) is a makeup result according to an embodiment of the present invention. Additionally, FIG. 21 shows a result of changing hair or lenses, and FIG. 22 shows a result of reflecting a makeup degree (makeup lightly↔heavily).

Since matters not described regarding the virtual makeup service providing method of FIGS. 2 to 22 as described above are the same as the content described regarding the virtual makeup service providing method through FIG. 1 above or can be easily inferred from the described content, a description below will be omitted.

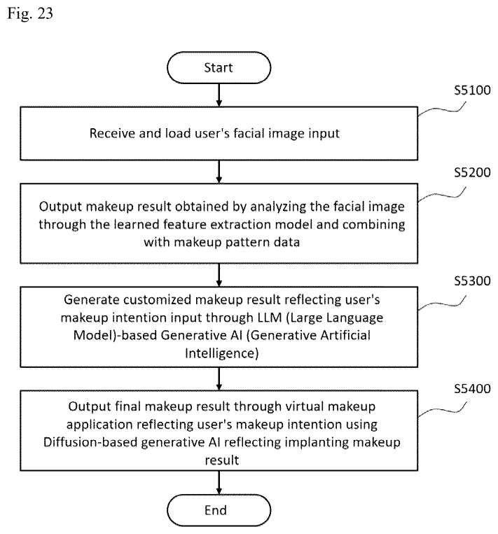

FIG. 23 is a drawing showing a process in which data is transmitted and received between each configuration included in a virtual makeup solution providing system using generative AI of FIG. 1 according to an embodiment of the present invention. Hereinafter, an example of a process in which data is transmitted and received between each configuration will be described through FIG. 23, but the present application is not limitedly interpreted by such an embodiment, and it is obvious to a person skilled in the art that a process in which data shown in FIG. 23 is transmitted and received may be changed according to various embodiments described above.

Referring to FIG. 23, the makeup service providing server receives a face image from a user terminal (S5100), and analyzes and classifies the face image with a pre-built feature extraction model to output facial feature information (S5200).

In addition, the makeup service providing server inputs the facial feature information into a pre-built LLM (Large Language Model)-based generative AI (Generative Artificial Intelligence) to extract a makeup color corresponding to the facial feature information (S5300), and outputs a makeup image with virtual makeup applied using diffusion-based generative AI that implants the extracted makeup color onto the face image (S5400).

The order of the above-described steps (S5100-S5400) is merely exemplary and is not limited thereto. That is, the order of the above-described steps (S5100 to S5400) may be mutually changed, and some of these steps may be simultaneously executed or deleted.

Since matters not described regarding the virtual makeup service providing method of FIG. 23 as described above are the same as the content described regarding the virtual makeup service providing method through FIGS. 1 to 22 above or can be easily inferred from the described content, a description below will be omitted.

The virtual makeup service providing method according to an embodiment described through FIG. 23 may also be implemented in a form of a recording medium including instructions executable by a computer, such as an application or a program module executed by a computer. A computer-readable medium may be any available medium that can be accessed by a computer, and includes both volatile and nonvolatile media, and removable and non-removable media. In addition, the computer-readable medium may include all computer storage media. A computer storage medium includes both volatile and nonvolatile, removable and non-removable media implemented in any method or technology for storage of information such as computer-readable instructions, data structures, program modules, or other data.

The virtual makeup service providing method according to an embodiment of the present invention described above may be executed by an application basically installed in a terminal (this may include a program included in a platform or an operating system and the like basically loaded in the terminal), and may also be executed by an application (that is, a program) directly installed by a user in a master terminal through an application providing server such as an application store server, an application, or a web server related to a corresponding service. In this sense, the virtual makeup service providing method according to an embodiment of the present invention described above may be implemented as an application (that is, a program) basically installed in a terminal or directly installed by a user, and may be recorded in a recording medium readable by a computer such as a terminal.

The following is an enumeration of embodiments of the present invention.

Item 1 is a virtual makeup solution providing system using generative AI comprising: a user terminal that photographs a face and outputs a makeup image with virtual makeup applied to the face; and a makeup service providing server including a receiving part that receives a face image from the user terminal, a feature extraction part that analyzes and classifies the face image with a pre-built feature extraction model to output facial feature information, a color extraction part that inputs the facial feature information into a pre-built LLM (Large Language Model)-based generative AI (Generative Artificial Intelligence) to extract a makeup color corresponding to the facial feature information, and a virtual makeup part that outputs a makeup image with virtual makeup applied using diffusion-based generative AI that implants the extracted makeup color onto the face image.

Item 2 is the virtual makeup solution providing system using generative AI of item 1, wherein the pre-built feature extraction model recognizes a contour line of a face and facial components, selects facial feature points, analyzes a length, a ratio, and an angle of each part, and uses BiseNet (Bilateral Segmentation Network for Real-time Semantic Segmentation) to extract a skin tone of the face, a lip color, and an iris color.

Item 3 is the virtual makeup solution providing system using generative AI of items 1 to 2, wherein the pre-built feature extraction model uses ResNet (Residual Neural Network), which is a classification model that classifies a face on the basis of preset classification items, based on the contour line of the face, facial components, facial feature points, a length, a ratio, and an angle of each part, a skin tone of the face, a lip color, and an iris color.

Item 4 is the virtual makeup solution providing system using generative AI of items 1 to 3, wherein the pre-built LLM-based generative AI is trained using instruction tuning with a dataset of facial feature information and makeup colors, and then, when the facial feature information is input into the LLM-based generative AI, outputs a keyword of the makeup color.

Item 5 is the virtual makeup solution providing system using generative AI of items 1 to 4, wherein the diffusion-based generative AI is Stable Diffusion, which is a Latent Diffusion Model.

Item 6 is the virtual makeup solution providing system using generative AI of items 1 to 5, wherein the diffusion-based generative AI converts the keyword of a makeup color output from the LLM-based generative AI into a prompt to generate the makeup image.

Item 7 is the virtual makeup solution providing system using generative AI of items 1 to 6, wherein the diffusion-based generative AI divides the face image into a preset makeup area, converts the keyword of the makeup color into a prompt for the divided makeup area to generate a unit makeup image; and then inserts and replaces the unit makeup image back into a face image, which is an original image, to generate the makeup image.

Item 8 is the virtual makeup solution providing system using generative AI of items 1 to 7, wherein the makeup service providing server further includes a selection reflection part that, after a makeup color corresponding to the facial feature information is extracted, transmits a lip color among the makeup colors to the user terminal, and when a desired lip color is selected in the user terminal, extracts and presents an eye shadow color and a blusher color corresponding to the selected lip color based on a pre-built database.

Item 9 is a virtual makeup solution providing method using generative AI executed by a makeup solution providing server, the method comprising: receiving a face image from a user terminal; analyzing and classifying the face image with a pre-built feature extraction model to output facial feature information; inputting the facial feature information into a pre-built LLM (Large Language Model)-based generative AI (Generative Artificial Intelligence) to extract a makeup color corresponding to the facial feature information; and outputting a makeup image with virtual makeup applied using diffusion-based generative AI that implants the extracted makeup color onto the face image.

Item 10 is the virtual makeup solution providing method using generative AI of item 9, wherein the LLM-based generative AI is generative AI learned with instruction tuning using a dataset of facial feature information and makeup colors.

The description of the present invention described above is for illustration, and a person having ordinary knowledge in the technical field to which the present invention pertains will be able to understand that it can be easily modified into another specific form without changing the technical spirit or essential features of the present invention. Therefore, it should be understood that the embodiments described above are illustrative in all respects and not restrictive. For example, each component described as a single type may be implemented in a distributed manner, and likewise, components described as distributed may also be implemented in a combined form.

The scope of the present invention is indicated by the claims described below rather than the detailed description above, and all changes or modified forms derived from the meaning and scope of the claims and the equivalent concept thereof should be construed as being included in the scope of the present invention.

What is claimed is:

1. A virtual makeup solution providing system using generative Artificial Intelligence (AI), which comprises:
a user terminal configured to photograph a face and output a makeup image with virtual makeup applied to the face; and
a makeup service providing server including a receiving part that receives a face image from the user terminal, a feature extraction part that analyzes and classifies the face image with a pre-built feature extraction model to output facial feature information, a color extraction part that inputs the facial feature information into a pre-built LLM (Large Language Model)-based generative AI (Generative Artificial Intelligence) to extract a makeup color corresponding to the facial feature information, and a virtual makeup part that outputs a makeup image with virtual makeup applied using diffusion-based generative AI that implants the extracted makeup color onto the face image.

2. The virtual makeup solution providing system using generative AI according to claim 1, wherein the pre-built feature extraction model configured to recognize a contour line of a face and facial components; select facial feature points; analyze a length, a ratio, and an angle of each part; and use BiseNet (Bilateral Segmentation Network for Real-time Semantic Segmentation) to extract a skin tone of the face, a lip color, and an iris color.

3. The virtual makeup solution providing system using generative AI according to claim 2, wherein the pre-built feature extraction model is configured to use ResNet (Residual Neural Network), which is a classification model that classifies a face on the basis of preset classification items, based on the contour line of the face, facial components, facial feature points, a length, a ratio, and an angle of each part, a skin tone of the face, a lip color, and an iris color.

4. The virtual makeup solution providing system using generative AI according to claim 1, wherein the pre-built LLM-based generative AI is trained using instruction tuning with a dataset of facial feature information and makeup colors, and then, when the facial feature information is input into the LLM-based generative AI, outputs a keyword of the makeup color.

5. The virtual makeup solution providing system using generative AI according to claim 1, wherein the diffusion-based generative AI is Stable Diffusion, which is a Latent Diffusion Model.

6. The virtual makeup solution providing system using generative AI according to claim 5, wherein the diffusion-based generative AI is configured to convert a keyword of a makeup color output from the LLM-based generative AI into a prompt to generate the makeup image.

7. The virtual makeup solution providing system using generative AI according to claim 5, wherein the diffusion-based generative AI is configured to divide the face image into a preset makeup area; convert the keyword of the makeup color into a prompt for the divided makeup area to generate a unit makeup image; and then insert and replace the unit makeup image back into the face image, which is an original image, to generate the makeup image.

8. The virtual makeup solution providing system using generative AI according to claim 1, wherein the makeup service providing server further comprises:
a selection reflection part that, after a makeup color corresponding to the facial feature information is extracted, transmits a lip color among the makeup colors to the user terminal, and when a desired lip color is selected by the user terminal, extracts and presents an eye shadow color and a blusher color corresponding to the selected lip color based on a pre-built database.

9. A virtual makeup solution providing method using generative Artificial Intelligence (AI) executed by a makeup service providing server, the method comprising:
receiving a face image from a user terminal;
analyzing and classifying the face image with a pre-built feature extraction model to output facial feature information;
inputting the facial feature information into a pre-built LLM (Large Language Model)-based generative AI (Generative Artificial Intelligence) to extract a makeup color corresponding to the facial feature information; and
outputting a makeup image with virtual makeup applied using diffusion-based generative AI that implants the extracted makeup color onto the face image.

10. The virtual makeup solution providing method using generative AI according to claim 9, wherein the LLM-based generative AI is generative AI trained with instruction tuning using a dataset of facial feature information and makeup colors.
